(19) United States
(12) Patent Application Publication
(10) Pub. No.: US 2021/0059803 A1
(43) Pub. Date: Mar. 4, 2021

(54) METHOD AND APPARATUS FOR ANESTHETIZING ANIMALS RELATED APPLICATIONS

(71) Applicant: Euthanex Corporation, Bethlehem, PA (US)

(72) Inventor: David Anderson, Nazareth, PA (US)

(21) Appl. No.: 16/947,903

(22) Filed: Aug. 24, 2020

Related U.S. Application Data
(60) Provisional application No. 62/894,168, filed on Aug. 30, 2019.

(51) Int. Cl. A61D 7/04; F16K 1/54; G01L 19/00

(52) U.S. Cl. CPC A61D 7/04; A01K 1/031; G01L 19/0092; F16K 1/54

(57) ABSTRACT

A method and apparatus for anesthetizing animals is provided. The system is particularly suited for anesthetizing small laboratory animals such as mice, rats and similar mammals. The system may include a plurality of discharge elements such as breathers and/or chambers that are configured to direct the flow of anesthetizing fluid to the animals. Additionally, the system is designed to provide a flow of anesthetizing fluid at a constant flow rate to a plurality of discharge elements. The system includes a fluid controller that controls the flow of anesthetizing gas to provide a constant mass flow rate of anesthetizing gas during a procedure as the number of discharge elements that receive anesthetizing gas varies over time.

### RELATED APPLICATIONS

This application claims the benefit of priority of U.S. Provisional Application No. 62/894,168, filed on Aug. 30, 2019, the entire contents of which application(s) are incorporated herein by reference.

### FIELD OF THE INVENTION

The present invention relates to the field of anesthetizing animals, such as small mammals. In particular, the present invention provides a system for use in research and testing laboratories for safely and humanely anesthetizing animals.

### BACKGROUND

Frequently, many organizations, such as research organizations need to anesthetize animals, such as mice or rats that are used during research. One common way of anesthetizing small mammals is to expose the animals to isoflurane in an enclosure. However, frequently, the procedure is done by untrained individuals so that the animal unnecessarily suffers or are insufficiently anesthetized during the procedure.

### SUMMARY OF THE INVENTION

In light of the foregoing, it is desirable to provide a system that allows the safe and efficient anesthetization of animals. According to a first aspect, the present invention provides a laboratory system for anesthetizing animals with a anesthetizing gas. The system includes a supply of pressurized gas that includes oxygen and a vaporizer for providing an anesthetizing agent that is soluble in the pressurized gas to provide a flow of anesthetizing gas. The system further includes a fluid controller connectable with the supply of pressurized gas and the vaporizer. The fluid controller is configured to control the flow of gas from the supply to the vaporizer. The fluid controller includes a control valve for selectively controlling the flow of gas from the supply to the vaporizer. The control valve is configured to be controllable between an open position in which the valve is fully open and a closed position in which the valve is completely closed to prevent the flow of gas. The control valve also includes a plurality of intermediate positions in which the valve is partially opened. The fluid controller also includes a sensor for detecting a characteristic indicative of fluid flow rate through the control valve and a central controller for controlling the control valve. The system also includes a central controller configured to receive signals from the sensor indicative of the detected characteristic. The system further includes a plurality of discharge elements connected with the fluid controller for selectively receiving a flow of anesthetizing gas from the fluid controller. The discharge elements are configured to supply the anesthetizing gas to animals. The fluid controller includes a plurality of discharge control valves for selectively controlling the flow of anesthetizing gas from the fluid controller to the discharge elements. Each discharge control valve is configured to operate between an open position and a closed position. The system also includes a user interface configured for inputting operational parameters for a procedure. The operational parameters may include the number of discharge elements to be used during the procedure and the flow rate of anesthetizing gas to be provided to the discharge elements. The flow rate may be selected from among a variable range of flow rates. The central controller comprises memory for storing data regarding the operating parameters selected for the procedure using the user interface. The central controller is configured to control the control valve in response to both the stored operational parameters and the signals received from the sensor to provide the select flow rate of anesthetizing gas to the select number of discharge elements.

According to another aspect, the present invention provides a system in which the discharge elements comprise a chamber for enclosing an animal to be anesthetized or a breathing device configured to cover a portion of the head of an animal to direct anesthetizing gas.

According to yet another aspect, the present invention provides a system in which the sensor is a differential pressure sensor. The differential pressure sensor may comprise two inlets for connecting a first fluid line and a second fluid line. The first and second fluid lines may be in fluid communication with the control valve and the second fluid line may be configured to produce a difference in pressure as the flow increases and the difference in pressure may be relative to the first fluid line.

Additionally, according to another aspect, the present invention provides a system in which the central controller comprises stored data in its memory that correlates a series of target fluid pressures with a corresponding series of desired flow rates to each of the discharge elements. For “x” number of discharge elements and “y” number of desired flow rates, the stored data may include “y” target pressures wherein each target pressure corresponds to a desired flow rate for a given number of open discharge control elements. Additionally, the stored data may include a number of target pressures at least as great as the product of “x” and “y”. Further, for “n” being equal to the number of discharge control valves that are open during a procedure and “n” being variable over time during the procedure, the central processor may be configured to retrieve a different target pressure from memory when “n” varies between 1 and the number of discharge elements in the system.

According to yet another aspect, the present invention provides a laboratory system for anesthetizing animals with an anesthetizing gas that includes a fluid controller for controlling the flow of anesthetizing gas to a plurality of discharge elements configured to supply the anesthetizing gas to animals. The fluid controller includes a control valve, a sensor, a central controller, at least one discharge control valve and a user interface. The control valve may be configured to selectively control the flow of gas from a first reservoir to a second reservoir. Additionally, the control valve may be configured to be controllable between an open position in which the valve is fully open and a closed position in which the valve is completely closed to prevent the flow of gas. The control valve may also include a plurality of intermediate positions in which the valve is partially opened. The sensor may be configured to detect a characteristic indicative of fluid flow rate through the control valve. The central controller may be configured to control the control valve and may be configured to receive signals from the sensor indicative of the detected characteristic. The discharge control valve may be configured to selectively control the flow of anesthetizing gas from the fluid controller to the discharge elements. Additionally, the user interface may be configured to facilitate an operator inputting operational parameters for a procedure. The operational parameters may correspond to the number of discharge elements to be used during the procedure and the flow rate of anesthetizing gas to be provided to the discharge elements and the flow rate may be selected from among a variable range of flow rates. Additionally, the central controller may include memory for storing data regarding the operating parameters selected for a procedure using the user interface. The central controller may also be configured to control the control valve in response to both the stored operational parameters and the signals received from the sensor to provide the select flow rate of anesthetizing gas to the select number of discharge elements.

According to yet another aspect the present invention provides a method for calibrating a system for anesthetizing animals. The method includes the steps of opening a first discharge control element so that i=1, where “i” is equal to the number of the discharge elements that are open and providing a flow of fluid from the first reservoir to provide a flow of fluid to “i” number of discharge elements. The method may also include the steps of measuring the mass flow rate of the fluid flowing to the one discharge element and controlling the control valve to vary the measured flow rate until the measured mass flow rate corresponds with a desired flow rate. The method may also include the step of storing the pressure sensed by the sensor when the measured mass flow rate corresponds with the desired flow rate. The foregoing steps may then be repeated a plurality of time for a range of desired flow rates. Additionally, the method may include the step of repeating each of the foregoing steps for each number of open discharge control elements possible with the system.

### DESCRIPTION OF THE DRAWINGS

The foregoing summary and the following detailed description of the preferred embodiments of the present invention will be best understood when read in conjunction with the appended drawings, in which:

FIG. 1 is a perspective view of a system for anesthetizing animals;

FIG. 2 is a perspective view of fluid controller of the system illustrated in FIG. 1;

FIG. 3 is a front view of the fluid controller illustrated in FIG. 2 shown with the cover removed;

FIG. 4 is a diagrammatic view of the fluid path of the system illustrated in FIG. 1; and

FIG. 5 is a diagrammatic view of the interconnection of the electrical controls of the system illustrated in FIG. 1.

### DETAILED DESCRIPTION OF THE INVENTION

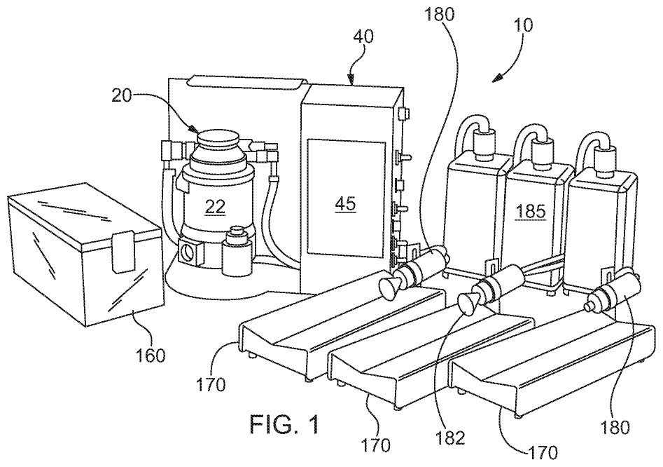

Referring now to the drawings in general, a system for anesthetizing animals is referred to generally as 10. The system 10 includes a fluid control assembly 40 that controls the flow of anesthetizing gas to provide a constant flow of anesthetizing gas for a variable number of animals of variable size. The fluid control assembly 40 may operate with a variety of anesthetizing agents, such an isoflurane vaporizer 20. Referring to FIG. 1, the system may include one or more chambers 160 for receiving an animal and one or more surgical beds 170 for receiving animals. Additionally, the system may include a chamber, such as an induction chamber 160 for initially anesthetizing an animal before the animal is placed on one of the surgical beds 170 for a procedure.

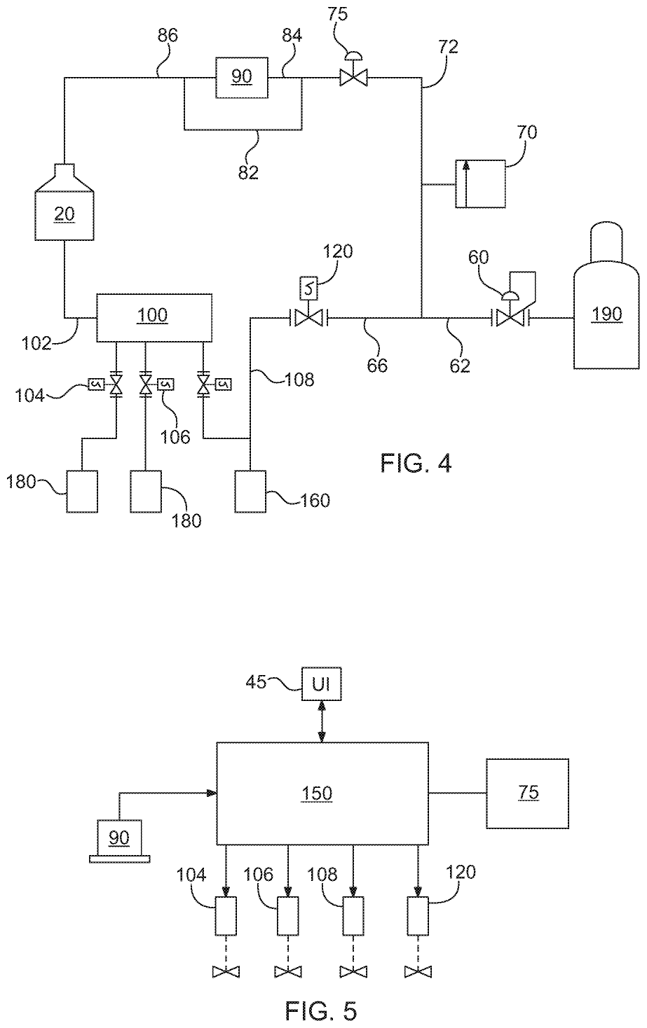

The fluid control assembly 40 provides an automated mechanism for controlling the flow rate of sedative gases to one or more output elements, such as the induction chamber 160 or one or more breathing devices 180 for one or more surgical beds. Referring now to FIG. 4, a brief overview of the fluid path through the fluid control assembly 40 will be described. A supply of pressurized air 190 is provided, such as a canister or tank of pressurized air. The pressurized air is connected with an inlet connector of the control assembly 40. A pressure regulator 60 regulates the pressure of the incoming air to reduce the fluid pressure to provide a constant fluid pressure for the incoming gas. From the pressure regulator 60 the fluid follows a fluid path 62 toward a control valve 75. From the pressure regulator, the fluid path branches off at a flush junction 65. At the flush junction, the primary fluid path branches into a flush path 66 and a primary line 67. The flush path 66 bypasses the control valve 75 and vaporizer 20 to provide a flow of air directly from the pressure regulator 60 to one of the discharge elements, such as the induction chamber 160. A flush valve 120 controls the flow of gas from the flush line 66 to the discharge elements, so that air only flows to the flush line if the flush valve is open. When the flush valve 120 is closed, gas flows from the pressure regulator 60 along the primary line 67 toward a pressure release junction 68. At the pressure release junction 68 a pressure release path 69 branches off from the primary line 72. If the pressure along the fluid path exceeds a predefined maximum value, a relief valve 70 vents the air through the pressure release path to reduce the fluid pressure in the fluid path.

The control valve 75 controls the flow of fluid along the primary path 72. Specifically, the control valve 75 controls the flow of gas to provide a constant flow rate of sedative gas to each discharge device regardless of how many discharge devices are being used. For instance, if the desired flow rate is 0.5 liters per minute (0.5 l/min) and both the induction chamber 160 and two of the breathing devices are being used, the control valve 75 will control the flow of gas to provide a constant flow of 0.5 l/min to both of the breathing devices. Since the flow of gas increases or decreases depending on the number of discharge devices and the desired flow rate, the control valve is configured to vary the flow of gas accordingly. Although a variety of control mechanisms can be utilized, in the present instance, the control valve 75 is a proportional valve.

From The control valve 75, the gas flows to a pressure sensor 90. However, in the present instance, the fluid line branches between the control valve 75 and the pressure sensor 90. Specifically, at a pressure junction 80 the fluid path branches so that a bypass line 82 bypasses the inlet of the pressure sensor 90 and an inlet line 84 connects with the pressure sensor. A sensor outlet line 86 connects with an output connector on the pressure sensor 90. In the present instance, the output line 86 intersects with the bypass line 82. As discussed further below, the pressure sensor is a differential sensor 90. Additionally, as discussed further below, the control valve 75 is operatively connected with the pressure sensor so that the control valve 75 controls the flow of fluid in response to signals from the pressure sensor.

From the pressure sensor 90, the gas flows to the vaporizer 20. The vaporizer saturates the air with a sedative element to provide a sedative gas. From the vaporizer 20, the sedative gas flows to a manifold 100 that is operable to selectively control the flow of sedative gas to one or more of the discharge elements 160, 180. For instance, the manifold may have a single inlet line 102 from the vaporizer and a plurality of outlet lines to the discharge elements 160, 180. A plurality of valves may control the flow of fluid from the manifold 100 depending upon which discharge elements are in use. For instance, a first manifold valve 104 may control the flow of sedative gas from the manifold 100 to a first breathing device 180; a second manifold valve 106 may control the flow of sedative gas from the manifold 100 to a second breathing device 180; and a third manifold valve may control the flow of sedative gas from the manifold 100 to the induction chamber 160.

As discussed above, the flow of fluid through the system is an open flow system. Specifically, the fluid flows from the fluid reservoir, such as a pressurized air tank 190, and discharges from the system at one of the breathing devices 180 or the induction chamber 160. The control assembly 40 controls the flow of fluid to control whether the fluid flows through the vaporizer 20 to provide a sedative gas or around the vaporizer to provide a flow of air.

The air may be compressed air from a container, such a portable air canister, or the air supply may be from a network of gas lines connected with a main pressurized tank or pump.

In the present instance, the system is configured to use a single anesthetizing gas, such as isoflurane the animal(s). For instance, in the following discussion, the gas is isoflurane from a vaporizer 20, which is used to anesthetize the animal(s) however, it should be understood that the system is not limited to the use of isoflurane from a vaporizer and that other gases may be used instead.

As illustrated in FIG. 5, an electronic central controller 150 is provided to control operation of the various flow control components of the system. The central controller 150 may be any of a variety of electronic controllers, including, but not limited to programmable logic controllers, microcontrollers and microprocessors. Referring to FIG. 5, among other elements, the central controller is connected with the control valve 75, the pressure sensor 90, the manifold valves 104, 106, 108 and the flush valve 120. In particular, the central controller 150 receives signals from the pressure sensor 90 and provides control signals to the control valve 75 in response to the signals received from the pressure sensor. Additionally, the central controller 150 receives input signals from a user interface 45, such as the number of discharge elements and the type of animal being sedated. The central controller then controls the control valve based on the input signals from the user interface. In this way, the central controller 150 provides signals to the various elements to control the operation of the system as discussed further below.

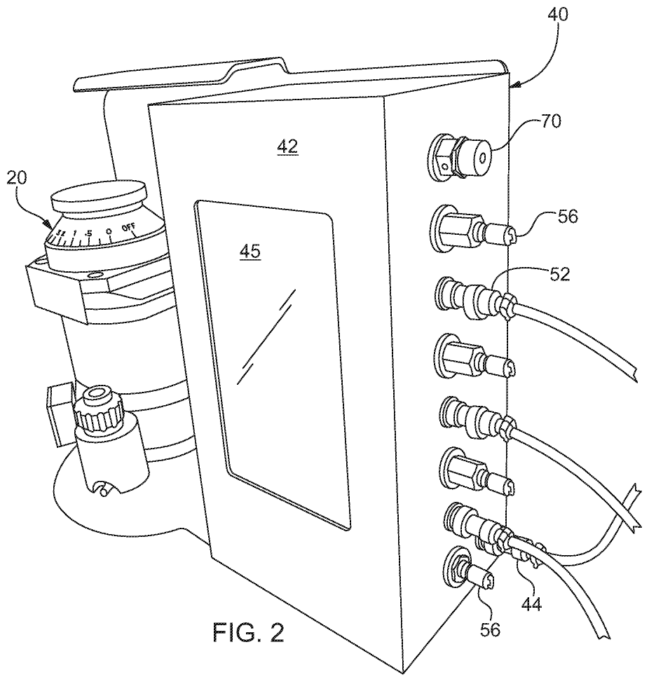

The elements of the fluid controller 40 will now be described in greater detail. As noted above, the fluid controller 40 incorporates an electronic controller 150. The central controller 150 provides control signals to various elements to control the operation of such elements based on signals that the central controller receives from various elements of the system. For instance, the system includes a user interface 45 that includes one or more elements that the user can operate to provide input signals. For instance, the user interface may include a plurality of buttons, a keyboard, a microphone for providing voice commands, a mouse, a scanner, such as a bar code scanner, a tablet or similar input device or a touch screen. It should be understood that such input devices are intended as examples and are not intended to limit the number or type of input elements that can be incorporated into the user interface. In the present instance, the user interface is a touch screen 45 as shown in FIG. 2. The touchscreen is an input/output device that allows the system to output information in a human recognizable form and receive input signals from the user to control the operation of the system. For instance, the touchscreen provides a mechanism that allows the operator to input information such as the desired flow rate for a procedure and the number of discharge devices being utilized (i.e. the number of breathing devices 180 and/or the induction chamber 160). The data input by the operator during the set-up of a procedure is then processed by the central controller 160 to control the operation of various elements of the fluid controller 40 during the procedure. Additionally, the user interface, such as touch screen 45, is configured to start the operating cycle. Further, the system displays information on the touch screen 45 regarding the progress of the cycle so that the user can monitor the progress of the system during an operating cycle. The fluid controller 40 includes a housing 42 that encloses the electronics and flow control elements. In the present instance, the touch screen 45 is mounted on the housing 42. However, the touchscreen may be a separate element that is separable from the housing 42.

As discussed above, the fluid controller includes a number of elements for controlling the flow of fluid through the fluid controller. For instance, gas entering the inlet may not be sufficiently controlled so that the gas pressure varies over time or the gas pressure is higher than optimal. Therefore, the fluid controller includes pressure regulator 62 at the inlet from the gas supply 190. For instance, the pressure regulator may be a pressure regulator pre-set to a fixed output pressure to reduce the incoming gas to a fluid pressure of 13 psi to provide a generally constant fluid pressure. From the pressure regulator 60, the reduced pressure gas flows along a fluid path 62. A flush line 66 branches from the fluid path so that a supply of air can be provided directly to one of the discharge elements, such as the induction chamber 160. The supply of air flushes sedative gas from the induction chamber. The flush valve 120 controls the flow of gas to the flush line 66. The flush valve 120 is normally closed to prevent the flow of gas through the flush line. The flush valve may be manually operable so that the operator needs to manually open the flush valve to flush the induction chamber 160. However, in the present instance, the flush valve is an electronically controlled valve 120 that is operatively connected with the central controller 150. Specifically, the flush valve 120 may be a two-way normally controlled solenoid valve. Accordingly, the flush valve 120 is preferably biased toward the closed position. The flush valve may be in electrical communication with the central controller 150 so that when the flush line is to be opened, the central controller provides a signal to energize the solenoid of the flush valve to open the flush valve.

If the flush valve 120 is closed gas flows toward a control valve 75 that controls the flow of gas through the gas line. An automatically actuable relief valve 70 is disposed along the fluid path so that if the fluid pressure along the fluid path exceeds a predetermined threshold, the relief valve vents gas from the fluid path to relieve the fluid pressure. For example, the relief valve may be a pop-off valve that is biased toward a closed position. When the fluid pressure in the fluid line exceeds a pre-defined threshold, the hydraulic force from the fluid pressure in the line overcomes the biasing force in the valve to open the valve so that gas from the line vents outside the housing 42 of the fluid controller. The valve remains open until the fluid pressure in the line falls below the pre-defined threshold and the bias in the valve overcomes the hydraulic force from the pressure in the line so that the biasing element in the valve closes the valve.

The control valve 75 controls the flow of gas through the system. The control valve 75 is operable to provide a constant flow rate of sedative gas to the discharge elements 160, 180 that are in use during a procedure. Since the number of discharge elements being used is variable for different procedures, the flow required through the system depends on the number of discharge elements in use. Similarly, the type of animal be sedated also affects the required flow rate. It is desirable to provide a control mechanism that is variable to provide the appropriate flow rate based on variables such as the number of discharge elements used during a procedure and the type of animal being sedated.

Although a number of control valve may be used to control the flow of gas, in the present instance, the system includes a proportional valve 75. The proportional valve 75 includes a solenoid valve that responds proportional to electric control signal applied to the control valve. In this way, the control valve 75 is configured to variably open between a fully open position and a fully closed position. Accordingly, the control valve is operable to provide a number of pre-defined different partially open positions each separate position providing a different flow rate between the full flow when the valve is completely open and no flow when the valve is closed. The different pre-defined valve positions are programmed into the central controller. In this way, in response to a signal from the central controller 150, the control valve 75 may open a pre-set amount to provide a predetermined flow of gas.

The sensor 90 downstream from the control valve 75 detects a characteristic of the gas indicative of the flow rate of the gas along the fluid path. The sensor 90 provides signals to the central controller 150 regarding the detected characteristic. The central controller 150 then controls the operation of the control valve 75 in response to the signals received from the sensor 90 to maintain the control valve in a position that provides the desired flow rate.

The sensor 90 may be any of a variety of sensors configured to detect a characteristic indicative of the flow rate of fluid along the fluid path. One characteristic that correlates with the flow rate is the fluid pressure of the fluid in the fluid path. Accordingly, sensor 90 may be configured to detect a characteristic indicative of the fluid pressure in the fluid path. In the present instance, sensor 90 is a differential sensor. Specifically, sensor 90 comprises a first inlet connected with fluid line 84 coming directly from the outlet of control valve 75. Sensor 90 further includes a second inlet connected with fluid line 86. The differential sensor detects the pressure difference between the fluid pressure in second inlet line 86 and the fluid pressure in first inlet line 84. The fluid path is designed to produce a difference in pressure as the flow increases. In particular, the fluid path between the control valve 75 and the second inlet line 86 is configured to produce a difference in pressure as the flow increases. For example, second inlet line 86 is connected with bypass line 82, which is an elongated fluid path relative to the first inlet line 84. The combined length of the bypass line 82 and the second inlet line 86 provide a bypass path. The elongated bypass path provides greater fluid resistance than the first inlet line 84. In this way, bypass path 82, 86 is designed to produce a difference in pressure as the flow increases. To do so, the bypass path 82, 86 is longer than the first inlet line 84 to provide sufficient resistance to provide a measurable pressure differential across differential sensor 90. Preferably, the bypass path 82, 86 is at least twice as long as the first inlet line 84. More preferably, the bypass path 82, 86 is at least four times the length of first inlet line 84.

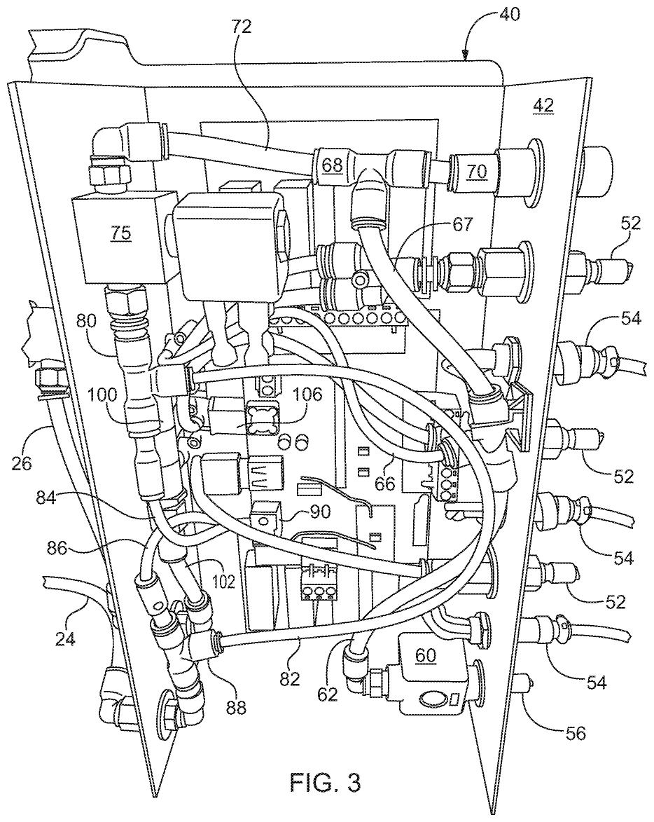

As shown in FIG. 3, the bypass line 82 is also connected with the vaporizer 20, so that fluid flows from the control valve 75 to the vaporizer. The vaporizer 20 comprises a tank having an inlet and an outlet. The tank contains a sedative agent, such as isoflurane or sevoflurane. In the present instance, the sedative agent is isoflurane. The inlet and outlet allow a flow of air to pass over the sedative agent in the tank. As the air passes over the sedative agent, the air becomes saturated with the sedative agent. The vaporizer includes an inlet line 24 connected with the inlet of the vaporizer and an outlet line 26 connected with the outlet of the vaporizer canister 22 to provide the flow of air from the fluid path through the control assembly 40. The vaporizer also includes an adjustment for adjusting the saturation rate of the sedative agent. For instance, the vaporizer may be configured to adjust the saturation between 0% and 5%.

In this way, the control assembly 40 provides a flow of gas, such as air to the vaporizer 20 via inlet line 24 and the vaporizer 20 saturates the air to provide an air/sedative mixture to provide a flow of sedative gas that exits the vaporizer via outlet line 26.

The manifold 100 is connected with the vaporizer outlet so that the manifold receives the flow of sedative gas. The flow of sedative gas from the manifold to the discharge elements 160, 180 is then controlled by a series of control valves. For instance, the flow of gas from the manifold may be controlled by a series of solenoid valves that are controlled by the central controller 150. As illustrated in FIG. 3, in an exemplary embodiment, the system may include an induction chamber 160 and two surgical beds 170, each of which includes a breathing device 180. The breathing device includes a nosecone 182 that fits over the nose of the animal as shown in FIG. 1. In this way, the induction chamber 160 and breathing devices 180 are the discharge elements connected with the manifold. However, it should be understood that the number and types of discharge may be varied to suit the needs of the environment. For instance, the system may include three surgical beds with three breathing devices 180 as the discharge elements, rather than having two breathing devices and an induction chamber. Additionally, the number of discharge elements may be varied. Although the system is illustrated with three discharge elements, the system may be varied to increase or decrease the number of discharge elements. For instance, the system may include three surgical beds with three breathing devices 180 and an induction chamber 160, thereby incorporating four discharge elements.

The fluid control system 40 is configured so that the flow of sedative gas from the manifold to each of the discharge elements is independently operable. In this way, the flow of sedative gas to each discharge element can be independently turned on or off. In the present instance, the system includes a plurality of control valves, such as solenoid valves. Referring to FIG. 4, a first control valve 104 controls the flow of fluid from the manifold 100 to the first discharge element, such as breathing device 180. A second control valve 106 controls the flow of fluid from the manifold 100 to the second discharge element, such as the second breathing device. A third control valve 108 controls the flow of fluid from the manifold to the third discharge element, such as induction chamber 160.

The control valves 104, 106, 108 may be controlled by the central controller 150 so that the central controller provides signals to the control valves in response to information selected for a procedure by the user. In particular, the control valves 104, 106, 108 may be normally closed two position solenoid valves. In a first position, each valve is open and in a second position each valve is fully open. If the user indicates that the induction chamber 160 and a single bed are to be used during a procedure, the system controls control valves 104 and 108 to open and close valves 104 and 108 and the appropriate time during the procedure. Specifically, the central controller 150 sends signals to automatically open and close the select valves at the appropriate time during a procedure as discussed further below.

In addition to controlling the flow of fluid, the control assembly also controls the heating of the surgical beds 170. The surgical beds may be formed of a conductive material to conduct heat. Additionally, each surgical bed may include a heating element, such as a resistive heating element. Each surgical bed may be connected with the control assembly via a power cable that selectively powers each surgical bed separately.

As shown in FIGS. 1, 2 and 5, the control assembly includes a plurality of electrical connectors 54 for connecting the surgical beds with the control assembly. The controller 150 selectively controls the connection of each electrical connector with the power supply so that the central controller selectively provides power to the heater of each surgical bed. In this way, the central controller 150 is configured to selectively control both the flow of gas through the system and the heating of the surgical beds.

As shown in FIG. 1, the system 10 may include an induction chamber 160. The induction may be an enclosed container connected with an inlet for providing a flow of sedative gas into the chamber. An animal may be placed in the chamber 160 while the animal is awake. The control assembly 40 then provides a flow of sedative gas to the chamber 160 for a set period of time to sedate the animal. Once the animal is sedated, the animal can be transferred to one of the surgical beds 170 for a procedure. Breather device, such as a nosecone 182 may be placed over the nose of the animal to provide a continuous supply of sedative gas to maintain the animal in a sedated condition during a procedure. The breathing apparatus, such as nosecone 182 may include two fluid lines. The first line provides a flow of sedative gas to the nosecone. The second fluid line is a drain line that drain excess sedative gas away from the nosecone. The drain line may be connected with a filter, such as a carbon filter 185, to filter the isoflurane from the drain line to reduce the amount of isoflurane entering the air surrounding the system.

### System Calibration

As discussed above, the system may be configured to measure a characteristic of the flow of fluid that is indicative of the flow rate of the fluid. The central controller then controls operation of the control valve to provide the desired flow rate based on the detected characteristic. In an exemplary embodiment, the system includes a differential sensor 90. In order to control the flow of gas to provide a uniform and constant flow of gas for a particular procedure, the system is calibrated to identify the flow rate provided through the system for a given pressure detected by sensor 90. The calibration process provides a table of pressure that correspond to desired flow rates based on the number of discharge elements being used during a procedure and the desired flow rate for the animal(s) being anesthetized during a procedure.

During the calibration process, a calibration meter, such as a mass flow meter is placed inline in the fluid path. The calibration meter measures the mass flow rate as the gas flows through the fluid line. For instance, the calibration meter may be connected to the gas fitting 52 for the induction chamber to read the mass flow rate of the gas to the induction chamber. The control valve 75 is opened to a first position corresponding with a first desired flow rate. When the calibration meter detects the first desired flow rate, the pressure detected by sensor 90 is recorded. In this way, the pressure detected by sensor corresponds with the first desired flow rate. This process in repeated to provide a plurality of selected flow rates and the corresponding pressure sensed by the sensor for each selected flow rate. Additionally, this process is repeated for each varying number of discharge elements 160, 180 in use. Specifically, for a first desired flow rate with only one discharge element open (i.e. gas flowing only to either the induction chamber 160 or one of the breathers 180), the control valve 75 is varied until the mass flow meter indicates the desired flow rate while two of the discharge control valves are closed. Once the mass flow meter detects the first desired flow rate, the corresponding pressure detected by the sensor 90 is stored. The control valve 75 is then controlled to change the flow of fluid so that the mass flow meter reads a second desired flow rate while two of the discharge control valves are maintained in a closed position. When the mass flow meter detects the second desired flow rate the pressure detected by the sensor is stored. In this way, a series of pressures corresponding to a series of desired flow rates are stored. For instance, a table may be recorded that includes a series of desired flow rates and the corresponding pressure detected for each flow rate. In an exemplary embodiment, the system may be configured to provide a range of from 0.5 to 2.5 μmin in 0.25 l/min increments. During the calibration process, a series of flow rates from 0.5 l/min to 2.5 in 0.25 l/min increments are measured to obtain the corresponding pressure detected by sensor for each incremental flow rate while two of the discharge control valves (e.g. 104, 106) are closed. The same process is repeated while only a single control valve (e.g. 104, or 106) is closed. In this way, the calibration process provides a series of pressures that correspond to a series of flow rates while two discharge elements are used. This process is repeated for each number of possible discharge elements. For example, in the present instance, the process is repeated to provide a series of pressure that correspond to a series of flow rates when three discharge control valves are open (e.g. 104, 106, 108). If additional discharge elements are incorporated, the calibration process is repeated so that the calibration provides “n” series of pressure values that correspond to the desired number of flow rates in the operation range, wherein “n” is equal to the number of discharge elements. This data determined during the calibration stage is stored in memory that the central controller can retrieve during a procedure to control the operation of the control valve 75 to maintain the desired flow rate for the number of discharge elements in use.

### Method of Use

Configured as discussed above, the system may be operated to automatically provide a uniform flow of sedative gas to a variable number of discharge elements. To commence a procedure, the operator first enters information regarding the procedure into the system. For instance, the system may display a variety of options for commencing a procedure. The system may be configured to require set-up for each procedure or the system may allow the operator store pre-set configurations for certain procedures. In order to set the parameters for a procedure, the system prompts the user to enter various parameters to be used to control the various elements during the procedure. For instance, the system may prompt the user to enter the desired flow rate for the sedative gas. For instance, the display screen 45 may display a prompt to enter the desired flow rate. If the screen is a touch screen, the user may enter the information directly through the touch screen, such as by selecting a flow rate from a menu of flow rates or by manually increasing or decreasing the flow rate by pressing up/down arrows on the display. Additionally, the system prompts the user to enter the number and type of discharge elements being used during the procedure. Specifically, the system may prompt the user to indicate whether the induction chamber is being used and how many breathers 180 are being used. The user selected parameters are stored in memory to be retrieved by the central processor to control operation of various elements of the system during the procedure.

After the user enters the necessary operating parameters for the procedure, the system provides prompts to the operator as necessary and controls the operation of the flow of fluid during the procedure. For instance, after the set-up is complete, the system may prompt the user by displaying messages on the screen 45 directing the user to perform required steps, such as ensuring any shut-off valve on the oxygen tank is open or indicating that the user should manually adjust the vaporizer as necessary to provide the appropriate saturation for the animal to be anesthetized. Similarly, the display may include a prompt with a start button to start the procedure when desired.

If the induction chamber 160 is used during a procedure, the operator places the animal into the chamber and closes the chamber. The system commences by opening the control valve 108 to the induction chamber and by opening the control valve 75 to provide the desired flow of gas. The desired flow is calculated based upon the user selected parameters provided during setup. The control valves to the breathers 180 are maintained in a closed position. When the control valve 75 and the induction chamber valve 108 are opened, a flow of gas flows through the fluid path to the vaporizer 20. From the vaporizer 20 the sedative gas flows to manifold 100 and then into the chamber 160. After the animal is sedated, the animal can be transferred to one of the surgical beds 170 and the breather can be attached to the animal. Preferably, the system includes a timer and the central controller may provide the flow of anesthetizing gas for a pre-determined time. The pre-determined time may be set during the set-up mode. After the pre-set time, the system may provide a prompt indicating that the sedating period is completed and the animal can be transferred. This prompt may be any of a variety of prompts, including but not limited to an indicator light, a visual message on the display screen and/or an audible tone. The system may also provide a prompt for extending the sedating period if the animal shows signs that it is not completely sedated by the end of the sedating period. Alternatively, the system may simply provide a timer and the operator may determine when to end the flow of gas to the induction chamber.

At the end of the sedating period, the animal is transferred to one of the surgical beds and connected with one of the breathers. The system may prompt the operator to indicate which breather 180 the animal is to be connected. The central controller can then control the central valve 75 and the appropriate breather valve 104, 106 to provide the desired flow of sedative gas to the desired breather.

If additional animals are to be sedated, the process may continue by maintaining a flow of sedative gas to the induction chamber. Alternatively, the system may discontinue the flow of sedative gas to the induction chamber once the sedating period end. In particular, after the timer indicates the that sedating period has completed, the central controller 150 may control the chamber valve 108 to close the valve unless the operator overrides this automatic operation by extending the sedating period as discussed above. If the flow of sedative gas is discontinued after a sedating period, the system may include a prompt for the user to indicate when another animal is placed into the induction chamber. Once the user indicates that an animal is placed in the induction chamber, the flow of gas commences for the pre-defined sedating period.

The system may also include a prompt for indicating that the last animal in a procedure has been removed from the induction chamber. The system then flushes the induction chamber to flush the sedative gas from the chamber. Specifically, the central controller 150 provides control signals to the flush valve 120 to open the flush valve. Once opened, the flush line provides a flow of air directly from the inlet line 62. The controller may control the flush valve to keep the flush valve open for a predetermined period of time. At the end of the flush period the central controller may provide control signals to close the flush valve to discontinue the flow of air from the inlet line 62 to the induction chamber 160.

Additionally, it may be desirable to flush the induction chamber 160 after each animal is anesthetized to limit exposure of the operator to the anesthetizing gas. Therefore, the operator may flush the induction chamber prior to removing an animal from the induction chamber. When the induction chamber is flushed, the flow of air through the flush line will reduce the flow of fluid through the vaporizer so that the flow rate of anesthetizing gas to the breather(s) may be reduced during the flush process. However, the flush process generally only lasts a few second, so that the reduced flow to the breathers is sufficient to maintain the animals in an anesthetized condition.

Once the desired number of animals are on the corresponding number of beds 170 and breathers 180 the central controller will control the control valve 75 and the breather valves 104, 106 to provide a continuous flow of sedative gas at the selected rate during the procedure. After the user completes a procedure on one of the animals, the user may remove the animal from the breather and move the animal to a separate enclosure, such as a cage. The system may include a prompt to indicate that an animal is removed from a breather. In response, the central controller send control signals to close the corresponding breather valve and to control the control valve 75 to provide the necessary flow rate to the remaining breather(s) 180 and/or induction chamber 160.

As described above, during a procedure, the number of discharge elements will vary over time. At certain times, only the induction chamber will be in use. At times, the induction chamber will be in use while one or more breather(s) are used to anesthetize one or more animals. The user may operate an input device to start or stop the flow of fluid to each select discharge element. For example, after an animal is anesthetized in the induction chamber the operator may press a stop button on the touch screen 45 to indicate that the initial process in the induction chamber is complete. The central controller provides a signal to discharge control valve 108 to close the discharge control valve. The operator may then press a button on the touch screen 45 to indicate that the first breather is to be opened. In response, the central controller 150 provides signals to control discharge valve 104 to open the first breather. Additionally, the central controller 150 retrieves the data regarding the pressure required to provide the desired flow rate when a single discharge element is open. The central controller then controls operation of the control valve 75 to incrementally open or close the valve in response to the pressure sensed by sensor 90 to provide a flow of gas at the pressure equal to the pressure value retrieved by the central controller.

While the first animal is on the first breather, the operator may place a second animal in the induction chamber. The operator may then press a button on the touchscreen display 45 to indicate that the flow of gas to the induction chamber should commence. In response, the central controller provides signals to control discharge valve 108. Additionally, since two discharge elements are now open, the central controller 150 retrieves the stored data regarding the pressure corresponding to the desired flow rate when two discharge elements are open. The central controller then provides signals to the control valve to control the flow of air through the control valve until the sensor 90 detects the pressure corresponding to retrieved data for the desired flow rate with two discharge elements open. In this way, the number of discharge elements in use during a process may change either automatically or in response to input from the operator. Each time the number of discharge elements in use changes, the system automatically changes the flow of fluid to ensure that the desired mass flow of gas is provided to the discharge elements in use. Specifically, each time the number of discharge elements in use changes, the system retrieves the stored data for the pressure corresponding to the desired flow rate for the number of discharge elements in use.

In the above description, the central controller controls the flow of fluid through the system by opening and closing different control valves based on pre-defined times and/or user prompts. In this way, the number of discharge elements may vary during a procedure. The central processor controls the various elements to provide the desired flow rates to the various discharge elements as the number of discharge elements varies during the procedure. However, it should be noted that it may be desirable to provide a continuous flow of sedative gas to the desired discharge elements during a procedure. In other words, if the user indicates that the induction chamber and two breathers will be used during a procedure, the system controls the flow of fluid to provide a continuous flow of sedative gas to the induction chamber and the two breathers during the entire procedure, even while the first animal is being sedated in the induction chamber.

As discussed above, the number of discharge elements may vary during a procedure. In other words, the flow rate of air required to provide the desired flow rate of sedative gas at the discharge elements may vary over time during the procedure. The central controller may calculate the required flow rate of air required at any point during the procedure based on the number of discharge elements in use at such point of the procedure and based on the stored information regarding the desired flow rate set by the operator during the set-up procedure.

Once the required flow rate of air is determined based on the number of discharge elements and the desired flow rate to each discharge element, the central controller controls the operation of the control valve 75 to provide the appropriate flow of air to the vaporizer. In particular, the central controller controls the operation of the control valve 75 based on the data from the calibration process that is stored in the memory. Specifically, the central processor determines the pressure corresponding to the desired flow rate for the number of discharge elements in use as determined during the calibration process. Once the appropriate pressure is determined, the central controller controls the control valve in response to the pressure detected by sensor 90. If the pressure is below the appropriate pressure, the central processor provides a signal to open the control valve further. This continues until the pressure sensed by the sensor raises to the appropriate pressure. Similarly, if the pressure sensed by sensor 90 is above the appropriate pressure, the central controller provides signals to the control valve to incrementally close the control valve until the pressure sensed by the sensor reduces to the appropriate pressure. In this way, the central processor retrieves the set pressure level for the air based on the desired flow rate of sedative gas to a select number of discharge elements. The central controller then controls the operation of the control valve to incrementally open or close the control valve so that the pressure sensed by sensor 90 reaches the set pressure, wherein the set pressure is determined based on a stored value identified during the calibration process.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A laboratory system for anesthetizing animals with an anesthetizing gas, comprising:
a supply of pressurized gas, wherein the gas comprises oxygen;
a vaporizer for providing an anesthetizing agent wherein the anesthetizing agent is soluble in the gas to provide a flow of anesthetizing gas;
a fluid controller connectable with the supply of pressurized gas and the vaporizer wherein the fluid controller is configured to control the flow of gas from the supply to the vaporizer, wherein the fluid controller comprises:
a control valve for selectively controlling the flow of gas from the supply to the vaporizer, wherein the control valve is configured to be controllable between an open position in which the valve is fully open and a closed position in which the valve is completely closed to prevent the flow of gas and wherein the control valve comprises a plurality of intermediate positions in which the control valve is partially opened;
a sensor for detecting a characteristic indicative of fluid flow rate through the control valve;
a central controller for controlling the control valve, wherein the central controller receives signals from the sensor indicative of the detected characteristic;
a plurality of discharge elements connected with the fluid controller for selectively receiving a flow of anesthetizing gas from the fluid controller, wherein the discharge elements are configured to supply the anesthetizing gas to animals;
a plurality of discharge valves for selectively controlling the flow of anesthetizing gas from the fluid controller to the discharge elements, wherein each discharge valve is configured to operate between an open position and a closed position;
a user interface configured to allow an operator to input operational parameters for a procedure, wherein the operational parameters include the number of discharge elements to be used during the procedure and the flow rate of anesthetizing gas to be provided to the discharge elements, wherein the flow rate is selected from among a variable range of flow rates;
wherein the central controller comprises memory for storing data regarding the operating parameters selected for a procedure using the user interface;
wherein the central controller is configured to control the control valve in response to both the stored operational parameters and the signals received from the sensor to provide the select flow rate of anesthetizing gas to the select number of discharge elements.

2. The system of claim 1 wherein the discharge elements comprise a chamber for enclosing an animal to be anesthetized or a breathing device configured to cover a portion of the head of an animal to direct anesthetizing gas.

3. The system of claim 1 wherein the sensor is a differential pressure sensor.

4. The system of claim 3 wherein the differential pressure sensor comprises two inlets for connecting a first fluid line and a second fluid line, wherein the first and second fluid lines are in fluid communication with the control valve and the second fluid line is configured to produce a difference in pressure as the flow increases, wherein the difference in pressure is relative to the first fluid line.

5. The system of claim 1 wherein the central controller comprises stored data in its memory that correlates a series of target fluid pressures with a corresponding series of desired flow rates to each of the discharge elements.

6. The system of claim 5 wherein for a system including “x” number of discharge elements and “y” number of desired flow rates, the stored data comprises “y” target pressures wherein each target pressure corresponds to a desired flow rate for a given number of open discharge elements.

7. The system of claim 6 wherein the stored data includes a number of target pressures at least as great as the product of “x” and “y”.

8. The system of claim 5 wherein “n” is the number of discharge valves that are open during a procedure and “n” is variable over time during the procedure and wherein the central processor is configured to retrieve a different target pressure from memory when “n” varies between 1 and the number of discharge elements in the system.

9. A laboratory system for anesthetizing animals with an anesthetizing gas, comprising:
fluid controller connectable with a first reservoir of pressurized gas and a second reservoir of anesthetizing agent that can be mixed with the pressurized gas to provide an anesthetizing gas, wherein the fluid controller comprises:
a plurality of discharge elements connected with the fluid controller for selectively receiving a flow of anesthetizing gas from the fluid controller, wherein the discharge elements are configured to supply the anesthetizing gas to animals;
wherein the fluid controller comprises:
a control valve for selectively controlling the flow of gas from the first reservoir to the second reservoir, wherein the control valve is configured to be controllable between an open position in which the valve is fully open and a closed position in which the control valve is completely closed to prevent the flow of gas and wherein the control valve comprises a plurality of intermediate positions in which the valve is partially opened;
a sensor for detecting a characteristic indicative of fluid flow rate through the control valve;
a central controller for controlling the control valve, wherein the central controller is configured to receive signals from the sensor indicative of the detected characteristic;
a plurality of discharge control elements for selectively controlling the flow of anesthetizing gas from the fluid controller to the discharge elements;
a user interface for inputting operational parameters for a procedure, wherein the operational parameters correspond to the number of discharge elements to be used during the procedure and the flow rate of anesthetizing gas to be provided to the discharge elements, wherein the flow rate is selected from among a variable range of flow rates;
wherein the central controller comprises memory for storing data regarding the operating parameters selected for a procedure using the user interface;
wherein the central controller is configured to control the control valve in response to both the stored operational parameters and the signals received from the sensor to provide the select flow rate of anesthetizing gas to the select number of discharge elements.

10. A method for calibrating the system of claim 9 wherein the system has “n” number of discharge elements, comprising the steps of:
a) opening a first discharge control element so that i=1, where “i” is equal to the number of the discharge control elements that are open;
b) providing a flow of fluid from the first reservoir to provide a flow of fluid to “i” number of discharge elements;
c) measuring the mass flow rate of the fluid flowing to the one discharge element;
d) controlling the control valve to vary the measured flow rate until the measured mass flow rate corresponds with a desired flow rate;
e) storing the pressure sensed by the sensor when the measured mass flow rate corresponds with the desired flow rate;
f) repeating steps b-e for a range of desired flow rates; and
g) if “i”<“n” repeating steps b-f for i=i+1.
